(19) United States
(12) Patent Application Publication
(10) Pub. No.: US 2006/0289581 A1
(43) Pub. Date: Dec. 28, 2006

(54) Trunk-specific functional arrangement for a motor vehicle

(76) Inventors: Hartmut Bohlke, Wuppertal (DE); Wolfgang Sitzler, Wuppertal (DE)

Correspondence Address: FLYNN THIEL BOUTELL & TANIS, P.C., 2026 RAMBLING ROAD, KALAMAZOO, MI, 49008-1631, US

(21) Appl. No.: 11/473,635

(22) Filed: Jun. 23, 2006

(30) Foreign Application Priority Data
Jun. 24, 2005 (DE) 102005031070.2

(51) Int. Cl. B60R 7/00; B60R 9/00

(52) U.S. Cl. 224/543; 224/552; 224/554

(57) ABSTRACT

A trunk-specific functional arrangement for a motor vehicle has at least two parallel guide rails which are assigned to at least one trunk-boundary surface, at least one functional carriage being mounted in a longitudinally displaceable manner in each guide rail, and blocking apparatus being provided in order to arrest the functional carriage in a form-fitting manner relative to the guide rail. Each guide rail is assigned at least one functional carriage, and there is provided a transversely extending unit which is dimensionally stable at least in certain sections, and which extends between the guide rails and is connected to the functional carriage.

### CROSS-REFERENCE TO RELATED APPLICATIONS

This application is based on German Application No. 10 2005 031 070.2, filed Jun. 24, 2005, which is incorporated herein by reference.

### FIELD OF THE INVENTION

The invention relates to a trunk-specific functional arrangement for a motor vehicle, in particular a passenger vehicle, having at least two parallel guide rails which are assigned to at least one trunk-boundary surface, at least one functional carriage being mounted in a longitudinally displaceable manner in each guide rail, and blocking means being provided in order to arrest the functional carriage relative to the guide rail.

### BACKGROUND OF THE INVENTION

Such a trunk-specific functional arrangement is known from DE 101 49 186 B4. The known trunk-specific functional arrangement has a load-bearing eyelet which is guided with longitudinal displacement, in the manner of a functional carriage, in a guide rail. In order for it to be possible to arrest the load-bearing eyelet in a form-fitting manner in the guide rail, blocking means are provided, and these comprise, on the one hand, a manually actuable latching pin on the load-bearing eyelet and, on the other hand, a perforated latching rail integrated in the guide rail. A lashing strap or the like can be secured on the load-bearing eyelet.

### SUMMARY OF THE INVENTION

The object of the invention is to provide a trunk-specific functional arrangement of the type mentioned in the introduction which allows stowed goods to be secured to better effect.

This object is achieved according to the invention in that each guide rail is assigned at least one functional carriage, and in that there is provided a transversely extending unit which is dimensionally stable at least in certain sections, extends between the guide rails and is connected to the functional carriage. It is thus possible for the trunk to be better divided up and also for stowed goods to be secured to better effect. The guide rails preferably extend on mutually opposite side regions of the trunk, so that the transversely extending unit can have an effect on the trunk over at least largely its entire width.

In a further configuration of the invention, the transversely extending unit is designed to be telescopic in at least one plane. The transversely extending unit is preferably telescopic in the vertical direction and/or in the longitudinal direction of the vehicle. The transversely extending unit can thus perform different functions. For example, in particular if it is telescopic in the vertical direction of the vehicle, it can be extended up to a window-base edge or up to a roof lining. If it is telescopic in the longitudinal direction of the vehicle, it can be extended, in particular in order to secure stowed goods, over just part of the length of the trunk or over largely the entire length of the trunk.

In a further configuration of the invention, the transversely extending unit is designed as a planar frame. The frame is of completely dimensionally stable configuration and preferably has a total of four frame profiles connected to one another in the manner of a quadrilateral.

In a further configuration of the invention, a netting arrangement is mounted in the frame. The netting arrangement is preferably of elastic design in order to be able to follow the telescopic behavior of the frame. As an alternative, the netting arrangement has, in the compressed position of the frame, a loose compensation region which is stretched out in the telescopically extended position of the frame. In the case of such a design, the netting arrangement does indeed have to be of likewise flexible design, but it may be of at least largely non-elastic configuration. The combination of the frame with the netting arrangement serves, in particular, for securing stowed goods on a corresponding trunk-boundary surface. The trunk-boundary surfaces are to be understood as being the trunk base, trunk side walls and front and rear trunk walls, the front and rear trunk walls being respectively formed by an inner side of a tailgate or rear door and by a rear side of a backrest arrangement of a rear seat bench.

In a further configuration of the invention, the frame is designed with at least one pair of mutually opposite frame legs of telescopic configuration. The telescopic behavior of the frame legs is achieved by leg profiles guided telescopically one inside the other.

In a further configuration of the invention, the transversely extending unit is designed as a dimensionally stable panel. This serves, in particular, for separating off, or dividing up, the trunk.

In a further configuration of the invention, the transversely extending unit is mounted on the functional carriage such that it can be pivoted about a pivot axis which runs transversely to the longitudinal axes of the guide rails. It is thus possible to orient the transversely extending unit between horizontal and upright functional positions, i.e. ones in which the unit projects upward at an acute or obtuse angle. Since, in addition, the functional carriages can also be displaced in the longitudinal direction of the guide rails, a high level of flexibility is ensured for the use of the transversely extending unit.

In a further configuration of the invention, means are provided in order to arrest the frame in a releasable manner on at least one trunk-mounted boundary surface, in at least one upright functional position. Such arresting means can be arrested or released, in particular, manually. The arresting means preferably interact in a form-fitting manner with corresponding retaining or securing mounts in the region of the trunk-boundary surfaces.

In a further configuration of the invention, means are provided in order to guide the transversely extending unit in at least one guide rail, the means being arranged on the transversely extending unit at a distance from the at least one functional carriage. It is thus possible to displace the transversely extending unit along the guide rail in a horizontally oriented functional position. This configuration is advantageous, in particular, if the transversely extending unit is mounted such that it can be pivoted relative to the functional carriages.

In a further configuration of the invention, the releasable arresting means comprise the means for guiding the transversely extending unit. This achieves a double function by the arresting means being designed such that they may also serve for guiding the transversely extending unit in the guide rails.

In a further configuration of the invention, the upright trunk-boundary surfaces contain functional mounts for securing or guiding the transversely extending unit in the upright functional position. The functional mounts are designed, in particular, as retaining or securing mounts and are preferably integrated in the mutually opposite trunk side walls. As an alternative, or in addition, corresponding retaining or securing mounts may be provided in the rear side of the backrest arrangement or in the region of the inner side of a tailgate or rear door.

### BRIEF DESCRIPTION OF THE DRAWINGS

Further advantages and features of the invention can be gathered from the claims and from the following description of preferred exemplary embodiments of the invention which are illustrated with reference to the drawings, in which:

FIG. 1 shows a perspective illustration of a trunk of a passenger vehicle with one embodiment of a trunk-specific functional arrangement according to the invention,

FIG. 2 shows the trunk-specific functional arrangement according to FIG. 1 in a different functional position,

FIG. 3 shows an enlarged, perspective illustration of a detail of the trunk-specific functional arrangement according to FIGS. 1 and 2,

FIG. 4 shows the trunk-specific functional arrangement according to FIGS. 1 and 2 in a further functional position,

FIG. 5 shows an enlarged, perspective illustration of a further detail of the trunk-specific functional arrangement according to FIGS. 1 to 4,

FIG. 6 shows the trunk-specific functional arrangement according to FIGS. 1 to 5 in a further functional position,

FIG. 7 shows the trunk-specific functional arrangement according to FIG. 6 with a horizontally oriented transversely extending unit,

FIG. 8 shows the embodiment according to FIG. 7 with the transversely extending unit displaced into a different horizontal position,

FIG. 9 shows the embodiment according to FIGS. 7 and 8 with the transversely extending unit extended telescopically in the longitudinal direction of the vehicle,

FIG. 10 shows the transversely extending unit according to FIG. 9 in a functional position in which it has been displaced rearward in the longitudinal direction of the vehicle,

FIG. 11 shows a further embodiment of a trunk-specific functional arrangement according to the invention,

FIG. 12 shows a further embodiment of a trunk-specific functional arrangement according to the invention in a first functional position,

FIG. 13 shows the trunk-specific functional arrangement according to FIG. 12 in a further functional position,

FIG. 14 shows a further embodiment of a trunk-specific functional arrangement according to the invention, and

FIG. 15 shows the trunk-specific functional arrangement according to FIG. 14 in a further functional position.

### DETAILED DESCRIPTION OF THE INVENTION

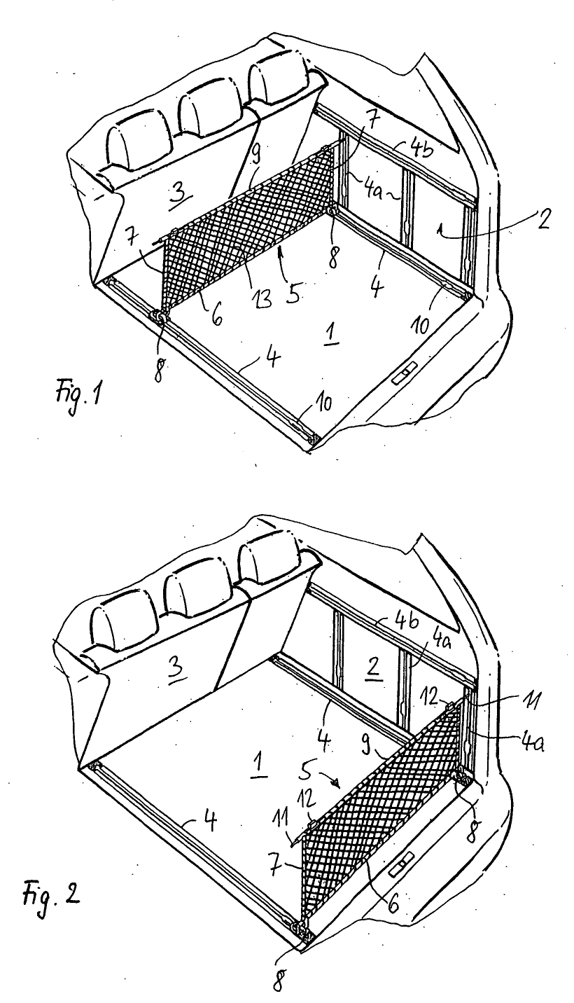

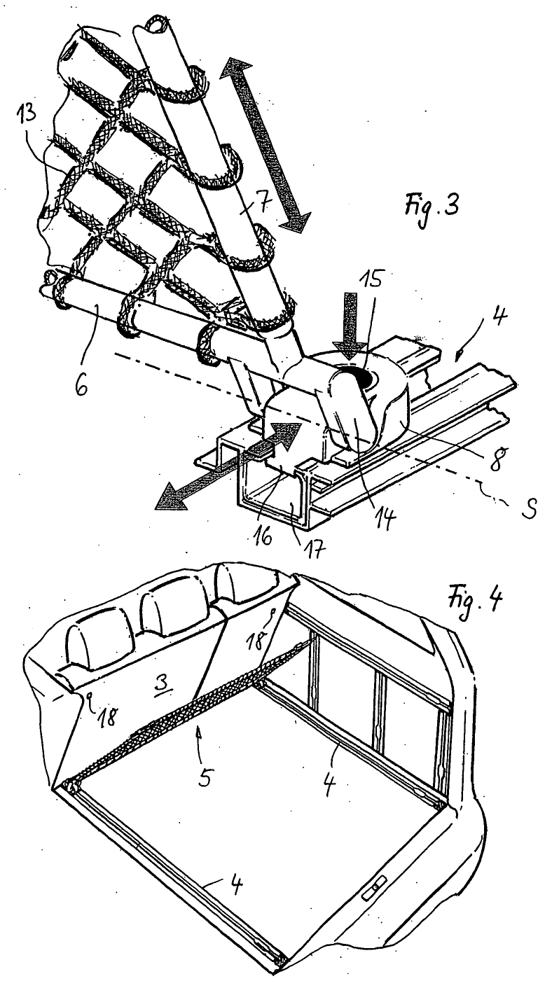

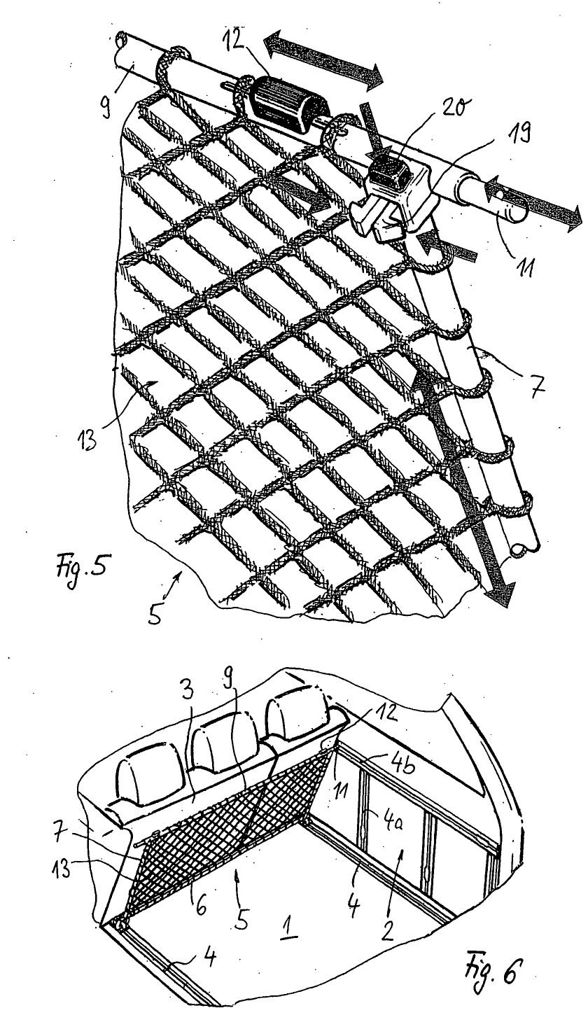

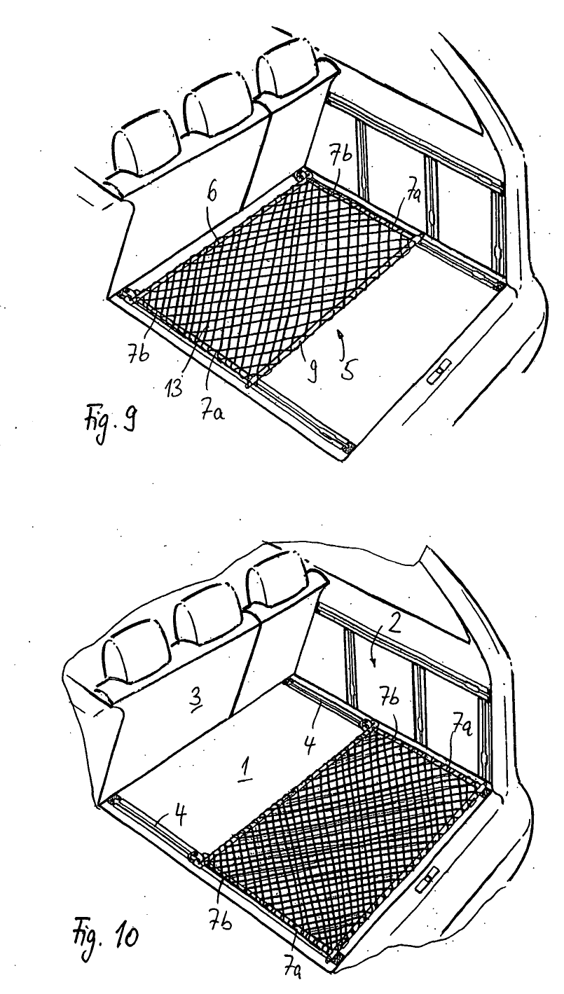

A trunk for a passenger vehicle is provided, according to FIGS. 1 to 11, with a trunk floor 1 which is bounded, in the direction of both sides of the vehicle, by a respective side wall 2 and toward the front, as seen in the normal direction of travel, by a rear side of a backrest arrangement 3 of a rear seat bench. The trunk can be closed toward the rear, in a manner which is known in principle, by a tailgate or a rear-door arrangement. Two guide rails 4 are integrated in the trunk floor 1, on opposite side-border regions, and extend over the entire length of the trunk floor 1 in the longitudinal direction of the vehicle. The two guide rails 4 are oriented parallel to one another. Two guide rails 4a, 4b are also integrated, in the opposite side walls, the exemplary embodiment illustrated having in each case three vertically upwardly running and uniformly spaced-apart guide rails 4a which begin at an abutment edge between the trunk floor 1 and side wall 2 and end just beneath a window-base edge. A horizontally running guide rail 4b is integrated in each side wall 2 so as to terminate flush with the top end-border regions of the guide rails 4a, and extends along the side wall, over the length of the trunk, in the longitudinal direction of the vehicle. Both the side walls and the trunk floor 1 form trunk-boundary surfaces. Integrating the guide rails 4, 4a, 4b in these trunk-boundary surfaces means that the guide rails are incorporated in the respective trunk-boundary surfaces and have their top side terminating essentially flush, and in alignment, with the respective trunk-boundary surface. All the guide rails 4 are fastened in a crash-proof state, in a manner which is not illustrated specifically, on corresponding body-structure parts.

Each guide rail is constructed from two C-shaped hollow profiles guided one inside the other, as can be seen with reference to FIG. 3. An outer hollow profile, which is not designated any more specifically, has, on its outside, a plurality of longitudinal crosspieces and longitudinal rib structures by means of which it is secured in the respective trunk-boundary surface. An inner latching profile 17 is fitted in the outer hollow profile, extends over the entire length of the outer hollow profile and has a C-shaped cross-sectional profile. The two profiles thus form a longitudinal slot which is open in the direction of the trunk and in which functional carriages 8 can be guided with longitudinal displacement in a manner which will be described more specifically hereinbelow. The latching profile is provided, over the entire length of the respective guide rail 4, 4a, 4b, with a row of latching holes, in which a latching bolt of the functional carriage 8 can engage in order to make it possible for the functional carriage 8 to be arrested in a longitudinally form-fitting manner in the respective guide rail 4. Each functional carriage 8 has an actuating button 15, by means of which it is possible to lock or release the functional carriage 8 relative to the respective guide rail 4, 4a, 4b. The guiding and latching principle of the functional carriage 8 relative to the guide rail 4 corresponds to a load-bearing arrangement as is known from DE 101 49 186 B4. This arresting principle from DE 101 49 186 B4 has been used for arresting the functional carriages 8 in the guide rails 4, 4a, 4b, so that reference can be made to DE 101 49 186 B4 for a more specific explanation of this arresting principle.

Each functional carriage 8 has a cross-sectionally (FIG. 3) T-shaped securing section 16 which engages behind the longitudinal-slot-flanking crosspiece borders of the profiles of the guide rail 4, 4a, 4b and thus performs the function of securing the functional carriage 8 in the direction transverse to the longitudinal direction of the respective guide rail 4, 4a, 4b. The functional carriage 8 is thus guided with longitudinal displacement, and sliding action, on the respective guide rail.

Each guide rail 4, 4a, 4b has, on its top side, an aperture 10 which is dimensioned such that the respective functional carriage 8 can be removed from the guide rail 4 at this location. The aperture 10 is thus dimensioned to be somewhat larger than a base surface area of the securing section 16 of the functional carriage 8.

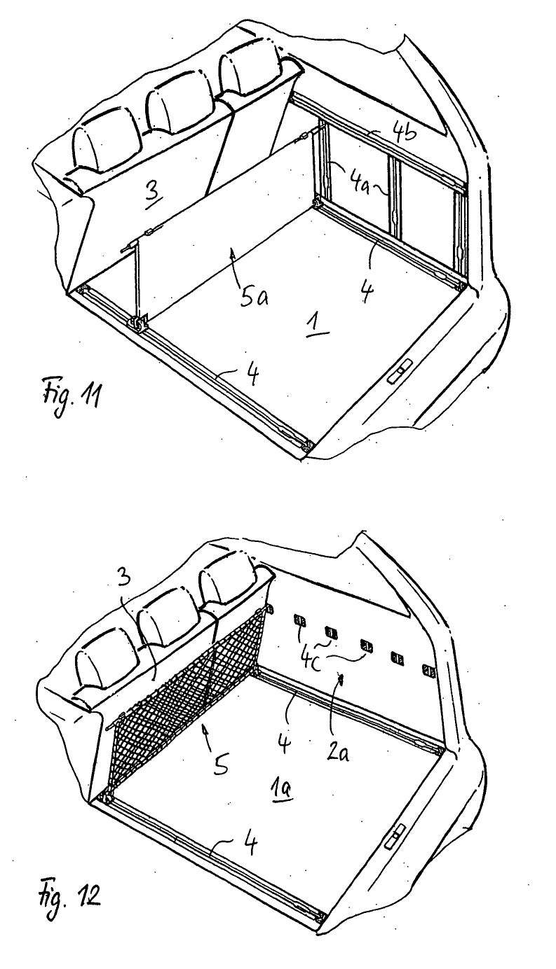

In the case of the embodiment illustrated according to FIGS. 1 to 10, a total of two functional carriages 8 are provided, a respective functional carriage 8 being arranged in a displaceable manner in a respective guide rail 4 of the trunk floor 1. As can be seen with reference to FIG. 3, each functional carriage 8 is provided with a pivot-bearing means, on which a transversely extending unit 5 is arranged such that it can be pivoted about a pivot axis S which extends in the transverse direction of the vehicle. The transversely extending unit 5 comprises a dimensionally stable frame 6, 7, 9. The frame has a bottom transverse profile 6 and a top transverse profile 9, which is oriented parallel to the bottom transverse profile 6. The top and the bottom transverse profiles 6, 9 are connected to one another by two telescopic longitudinal profiles 7 to form the quadrilateral frame. As can be seen with reference to FIGS. 9 and 10, each telescopic longitudinal profile 7 comprises two longitudinal-profile sections 7a, 7b which can be displaced telescopically one inside the other. The longitudinal-profile sections 7a, 7b, which can be displaced telescopically relative to one another, can be displaced relative to one another between a pushed-together position according to FIGS. 1, 2, 7 and 8 and an extended position according to FIGS. 9 and 10. It is thus also inevitably possible for the frame itself to be of different sizes. The longitudinal-profile sections 7a, 7b are preferably assigned arresting means (not illustrated specifically) which fix in relation to one another the lengths of the respective longitudinal profiles of the frame in the adjusted position of the longitudinal-profile sections 7a, 7b. It is possible here for the length of the respective longitudinal profile 7 to be changed in a stepwise or stepless manner. The arresting means serve for arresting the respectively adjusted length such that the dimensionally stable frame desired is achieved.

Mounted in the frame is a netting 13, of which the mounting surface can be changed as the profile length of the frame is changed. For this purpose, either the netting 13 is of elastic design, such that it is possible to compensate for the change in length of the frame by a correspondingly elastic compliance of the netting 13, or the netting has a longitudinal extent which corresponds to the maximum longitudinal extent of the longitudinal profiles 7a, 7b. In the latter case, when the frame is adjusted to a small size, the netting 13 is retained in a loose or hanging state.

In order for it to be possible to fix the transversely extending unit 5, and thus in particular the frame 6, 7, 9, on the side walls 2 in an upright position according to FIGS. 1, 2 and 4, securing pins 11 are integrated in the top transverse profile 9 of the frame, at the opposite ends of the latter, and can be displaced outward into an arresting position, or inward into a rest position, by manually actuable slides 12. The securing pins 11 can penetrate into corresponding grooves of the guide rails 4a or 4b integrated in the side walls 2, so that they secure the transversely extending unit, namely the frame including the mounted netting, in a form-fitting manner in the correspondingly upright position.

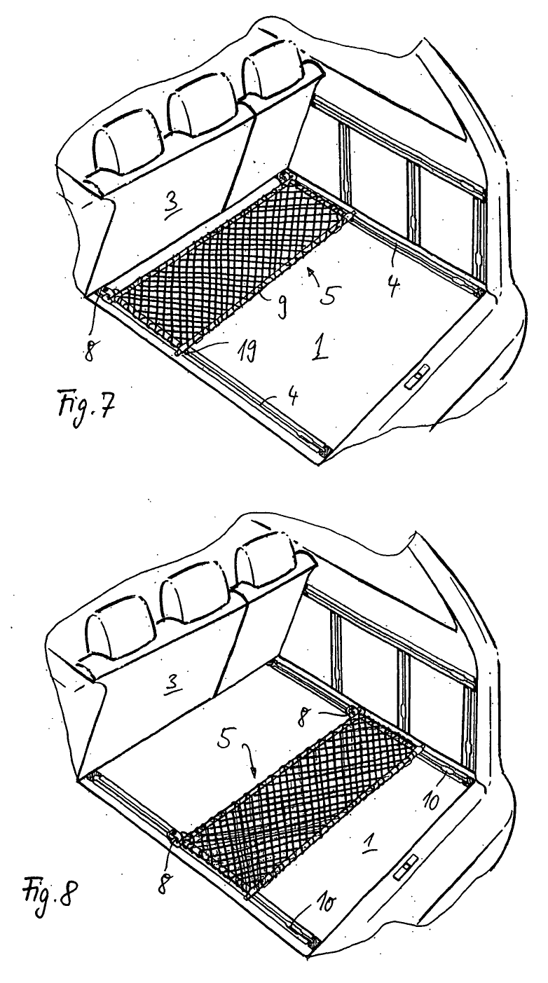

In order for it also to be possible for the frame 6, 7, 9 to be fixed securely in an upright functional position in the region of the rear side of the backrest arrangement 3 (FIG. 6), retaining mounts 18 are integrated in the rear side of the backrest arrangement 3. As can be seen with reference to FIG. 5, the transversely extending unit has, in the abutment region between the longitudinal profile 7 and top transverse profile 9, a respective latching element 19 which comprises two latching noses which can be moved in opposite directions to one another. The movement of the latching noses is brought about, on the one hand, by spring force and, on the other hand, by an actuating button 20, which acts on the latching noses. By virtue of the actuating button 20 being pushed, the latching noses, with are oriented outward in opposite directions to one another, can be moved toward one another. As soon as a corresponding compressive force is removed from the actuating button 20, the latching noses are pushed outward again by spring force and can engage behind a corresponding latching border within the respective retaining mount 18. Depending on how corresponding run-on slopes of the latching noses are formed, it is also possible to push the latching noses against the retaining mount 18, as a result of which they automatically move toward one another and, once past the latching opening of the respective retaining mounts 18, latch in behind the corresponding latching border.

In the case of an exemplary embodiment which is not illustrated, the transversely extending unit 5 may also be released from the functional carriages 8 in the region of the pivot-bearing means. Correspondingly releasable fastening means are provided for this purpose.

The latching means 19, 20, which serve for fastening the frame 6, 7, 9 on the backrest arrangement 3, can also be used to secure the transversely extending unit 5, in addition to the functional carriages 8, in the guide rails 4 and to guide it along the guide rails. For this purpose, the transversely extending unit 5, including the functional carriages 8, is straightforwardly removed from the guide rails 4 in the region of the apertures 10, rotated through 180° and reinserted into the apertures 10, and thus into the guide rails 4, with the functional carriages 8 correspondingly turned round. The transversely extending unit 5 can then be pivoted downward horizontally in the direction of the trunk floor 1, it being necessary for the latching means 19 to penetrate into the guide rails 4 in the region of the apertures 10. The latching noses of the latching means 19 are limited in their spring-loaded, pushed-apart position such that the latching noses engage behind the crosspiece borders of the groove of the respective guide rail 4 without the latching noses jamming in the region of the longitudinal slot. Rather, the latching noses are aligned with a small amount of play level with the longitudinal slots of the guide rails 4, so that it is easily possible for the transversely extending unit 5 to be displaced longitudinally in this horizontal floor position (FIGS. 7 to 10). Depending on the longitudinal adjustment position into which the longitudinal profiles 7, 7a, 7b have been adjusted, the transversely extending unit 5 has an extent, in the longitudinal direction of the vehicle, which corresponds approximately to a third of the length of the trunk floor 1 or somewhat more than half the length of the trunk floor 1.

In this horizontal floor position, the transversely extending unit 5 can be used, in particular, for securing stowed goods on the trunk floor 1. For this purpose, the transversely extending unit 5 is pivoted, while still upright, over the stowage goods which are to be secured, as a result of which the netting 13 curves upward. The latching means 19 are introduced into the guide rails 4 in the region of the apertures 10, and the entire transversely extending unit 5, or at least the top transverse profile 9, is then displaced in the longitudinal direction of the guide rails 4 until the latching means 19 are positioned in an undercut position in the region of the guide rails 4.

As an alternative, in the case of an exemplary embodiment of the invention which is not illustrated, it is. possible to adapt the width of the longitudinal slot of each guide rail 4, 4a, 4b to the width of the latching aperture of the retaining mounts 18, so that the latching means 19 can be pushed into the guide rails 4 from above at any desired location and the latching noses of the latching means 19 penetrate through the longitudinal slots of the guide rails 4 and, once past these longitudinal slots, engage behind the crosspiece borders of the longitudinal slot of each guide rail 4. Release can take place by the transversely extending unit, including the latching means, being displaced up to the apertures of the guide rail. The latching means are freed here.

The embodiment according to FIG. 11 corresponds essentially to the abovedescribed embodiment, the difference being that the transversely extending unit provided is a dimensionally stable panel 5a, which otherwise, in a manner analogous to the embodiment according to FIGS. 1 to 10, is mounted in a pivotable manner on two functional carriages and extends over the width of the trunk. On its end side which is located opposite the pivot axis, the dimensionally stable panel 5a has, on opposite side edges, securing pins which can be moved, via slides, between a rest position and an upright separating position, in which the panel is secured in the guide rails 4a, 4b of the side walls 2. The securing pins and the actuating slides are configured in a manner analogous to the abovedescribed exemplary embodiment, so that, for a more specific explanation, reference is made to what has been said relating to the embodiment according to FIGS. 1 to 10. The functional carriages also correspond to the functional carriages 8 according to FIGS. 1 to 10, so that, in this respect too, no further details will be given here.

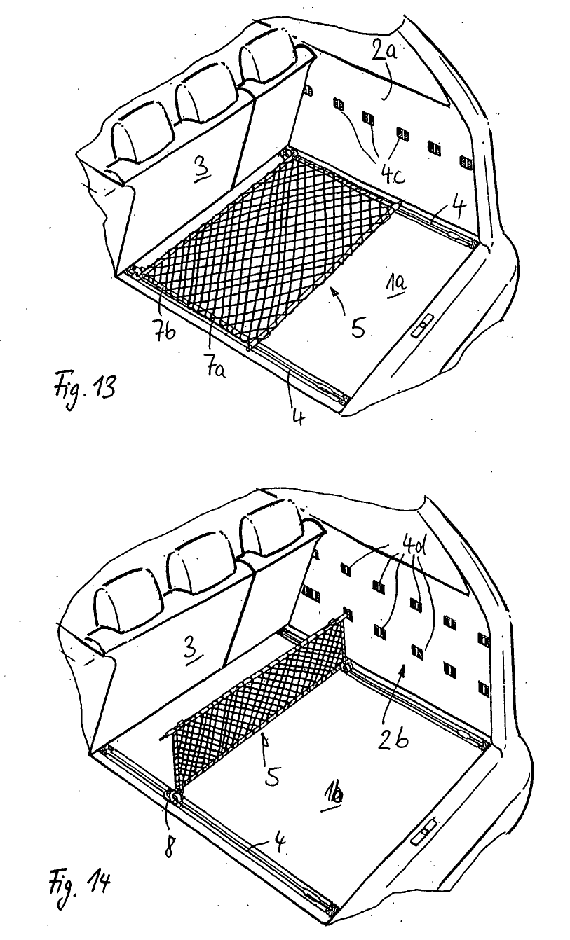

The embodiment which is illustrated with reference to FIGS. 12 and 13 corresponds essentially to the embodiment according to FIGS. 1 to 10. The only difference is that, in the case of this embodiment, retaining mounts 4c, rather than guide rails, are integrated in the side walls 2a. In this case, each side wall 2a is assigned a row of retaining mounts 4c running horizontally in the longitudinal direction of the vehicle. All the retaining mounts 4c are spaced apart uniformly from one another.

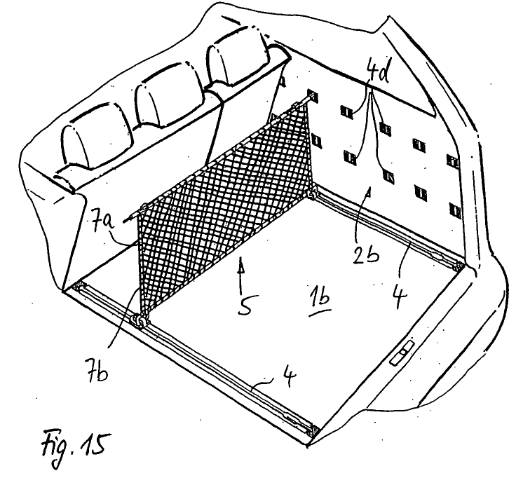

It is also the case with the embodiment according to FIGS. 14 and 15 that the only difference is that the side walls 2b contain not just one row of retaining mounts, but rather two parallel rows of retaining mounts 4d located one above the other. The bottom row of retaining mounts 4d is arranged in the respective side wall 2b approximately halfway to the level of the top row of retaining mounts 4d. The transversely extending unit 5 has a telescopic frame, the pushed-together position of the telescopic longitudinal profiles of the frame being dimensioned such that, in this pushed-together position, the transversely extending unit 5 can be positioned in the bottom row of retaining mounts 4d. In the extended position of the frame, in which the profile sections 7a and 7b have been extended telescopically, the transversely extending unit 5 according to FIG. 15 can be fixed in the top row of retaining mounts 4d.

What is claimed is:

1. Trunk-specific functional arrangement for a motor vehicle, in particular a passenger vehicle, having at least two parallel guide rails which are assigned to at least one trunk-boundary surface, at least one functional carriage being mounted in a longitudinally displaceable manner in each guide rail, and blocking means being provided in order to arrest the functional carriage relative to the guide rail, characterized in that each guide rail (4) is assigned at least one functional carriage (8), and in that there is provided a transversely extending unit (5, 5a) which is dimensionally stable at least in certain sections, extends between the guide rails (4) and is connected to the functional carriage (8).

2. Trunk-specific functional arrangement according to claim 1, characterized in that the transversely extending unit (5) is designed to be telescopic in at least one plane.

3. Trunk-specific functional arrangement according to claim 1, characterized in that the transversely extending unit comprises a planar frame (6, 7, 9).

4. Trunk-specific functional arrangement according to claim 3, characterized in that a netting arrangement (13) is mounted in the frame (6, 7, 9).

5. Trunk-specific functional arrangement according to claim 3, characterized in that the frame (6, 7, 9) is designed with at least one pair of mutually opposite frame profiles (7) of telescopic configuration.

6. Trunk-specific functional arrangement according to claim 1, characterized in that the transversely extending unit is designed as a dimensionally stable panel (5a).

7. Trunk-specific functional arrangement according to claim 1, characterized in that the transversely extending unit (5, 5a) is mounted on the functional carriage (8) such that it can be pivoted about a pivot axis S which runs transversely to the longitudinal axes of the guide rails (4).

8. Trunk-specific functional arrangement according to claim 3, characterized in that means (11, 12; 19, 20) are provided in order to arrest the frame (6, 7, 9) in a releasable manner on at least one trunk-mounted boundary surface (1, 2; 1a, 2a; 1b, 2b), in at least one upright functional position.

9. Trunk-specific functional arrangement according to claim 1, characterized in that means (19, 20) are provided in order to guide the transversely extending unit (5) in at least one guide rail (4), the means being arranged on the transversely extending unit (5) at a distance from the at least one functional carriage (8).

10. Trunk-specific functional arrangement according to claim 8, characterized in that the releasable arresting means comprise the means for guiding the transversely extending unit.

11. Trunk-specific functional arrangement according to claim 8, characterized in that the upright trunk-boundary surfaces (2, 2a, 2b) contain functional mounts (4c, 4d) for securing or guiding the transversely extending unit (5, 5a) in the upright functional position.
